(19) United States
(12) Patent Application Publication
(10) Pub. No.: US 2007/0025705 A1
(43) Pub. Date: Feb. 1, 2007

(54) Mother panel substrate for display device and method of manufacturing the same

(75) Inventors: Joo-Sun Yoon, Seoul (KR); Yong-Ho Yang, Suwon-si (KR); Ki-Hun Jeong, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/486,172

(22) Filed: Jul. 12, 2006

(30) Foreign Application Priority Data
Jul. 12, 2005 (KR) 2005-62474

(51) Int. Cl. H04N 7/00

(52) U.S. Cl. 386/97

(57) ABSTRACT

A mother panel substrate for a display device includes a base substrate and a cell identification display part. The base substrate includes a plurality of cell regions. The cell identification display part includes a plurality of cell identification marks on a plurality of cell regions which are adjacent to each other. The cell identification marks identify the cell regions.

### CROSS-REFERENCE TO RELATED APPLICATIONS

The present application claims priority from Korean Patent Application No. 2005-62474, filed on Jul. 12, 2005, the disclosure of which is hereby incorporated herein by reference in its entirety.

### BACKGROUND OF THE INVENTION

1. Field of the Invention

The present invention relates to a mother panel substrate for a display device and a method of manufacturing the mother panel substrate. More particularly, the present invention relates to a mother panel substrate for a display device capable of simplifying a manufacturing process and decreasing a manufacturing cost and a method of manufacturing the mother panel substrate.

2. Description of the Related Art

In order to manufacture a liquid crystal display (LCD) panel, a plurality of thin film transistor (TFT) substrates or a plurality of color filter substrates are formed on one mother panel substrate. The mother panel substrate is severed by each of the TFT substrates or each of the color filter substrates, and each of the TFT substrates is combined with each of the color filter substrates to form the LCD panel.

The LCD panel is manufactured through a mass production process using the mother panel substrate. In the mass production process, a plurality of identification marks are placed on the mother panel to facilitate subsequent division of the mother panel substrate into a plurality of regions corresponding to the TFT substrates or the color filter substrates.

The identification marks are classified as either a glass identification mark for each of mother panel substrates, or a cell identification mark for each of the TFT substrates or the color filter substrates, respectively. In a small screen display device for a cellular phone, or a touch panel the number of the TFT substrates or the color filter substrates in one mother panel substrate is increased so that the number of the cell identification marks is increased. Therefore, manufacturing time for forming the cell identification marks increases, and accordingly the manufacturing cost increases.

### SUMMARY OF THE INVENTION

The present invention provides a mother panel substrate for a display device capable of simplifying a manufacturing process and decreasing a manufacturing cost.

The present invention also provides a method of manufacturing the above-mentioned mother panel substrate.

A mother panel substrate for a display device in accordance with one embodiment of the present invention includes a base substrate and a cell identification display part. The base substrate includes a plurality of cell regions. The cell identification display part includes a plurality of cell identification marks on a plurality of cell regions that are adjacent to each other. The cell identification marks correspond to the cell regions, respectively.

A method of manufacturing a mother panel substrate for a display device in accordance with one embodiment of the present invention is provided as follows. A metal layer is formed on a base substrate having a plurality of cell regions. The metal layer is patterned to form a cell identification display part on a plurality of cell regions that are adjacent to each other. A plurality of cell identification marks corresponding to the cell regions, respectively, is formed on the cell identification display part.

The mother panel substrate is a huge substrate that may be used for manufacturing a plurality of TFT substrates, a plurality of color filter substrates, a plurality of LCD panels, a plurality of organic light emitting display (OLED) device.

According to the present invention, the mother panel substrate for manufacturing the display device includes the cell identification display part on adjacent two cell regions so that the number of the cell identification display parts is decreased. A plurality of cell identification marks is formed on each of the identification display parts. In addition, the number of the cell identification display parts and a path length of the titling device are decreased to save the manufacturing time of the cell identification marks. Therefore, the manufacturing time of the mother panel substrate is saved, thereby reducing the manufacturing cost of the mother panel substrate.

### BRIEF DESCRIPTION OF THE DRAWINGS

The above and other advantages of the present invention will become more apparent in light of the detailed description below of the exemplary embodiments with reference to the accompanying drawings, in which:

FIG. 1 is a plan view showing a mother panel substrate for a liquid crystal display (LCD) device in accordance with one embodiment of the present invention;

FIG. 2 is a plan view showing portion ‘A’ in FIG. 1;

FIG. 3 is a cross-sectional view taken along a line I-I′ in FIG. 2;

FIG. 4 is a plan view showing portion ‘B’ in FIG. 1;

FIG. 5 is a plan view showing portion ‘C’ in FIG. 4;

FIG. 6 is a cross-sectional view taken along line II-II′ of FIG. 4 and line III-III′ of FIG. 5;

FIG. 7 is a flow chart showing a method of manufacturing the mother panel substrate for the LCD device in FIG. 1;

FIG. 8 is a plan view showing a mother panel substrate for an LCD device in accordance with another embodiment of the present invention;

FIG. 9 is a plan view showing portion ‘D’ in FIG. 8;

FIG. 10 is a flow chart showing a method of manufacturing the mother panel substrate in FIG. 8;

FIG. 11 is a plan view showing a mother panel substrate for an LCD device in accordance with another embodiment of the present invention; and

FIG. 12 is a plan view showing portion ‘E’ in FIG. 11.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described below in detail with reference to the accompanying drawings.

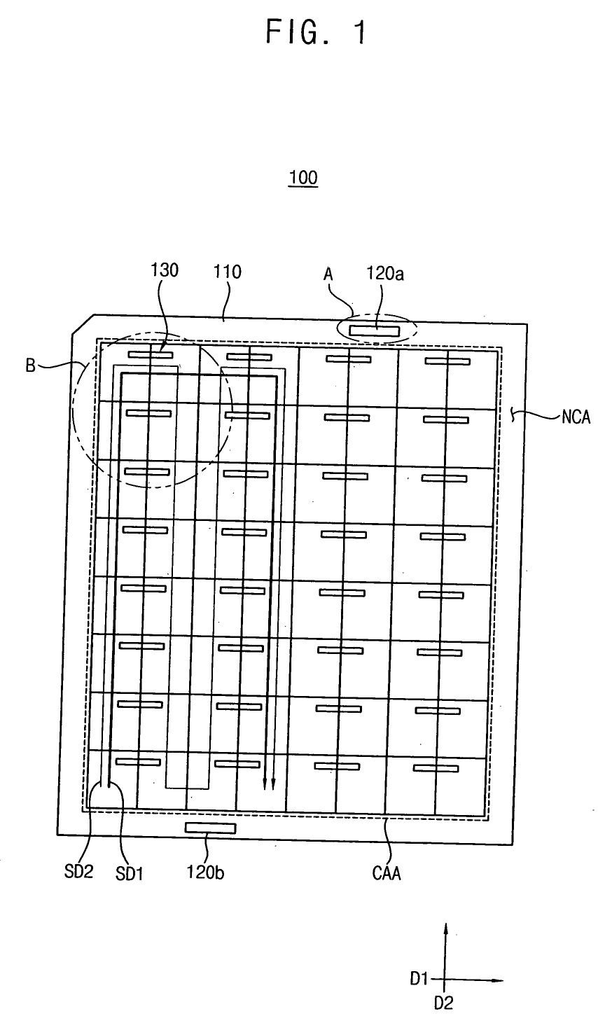

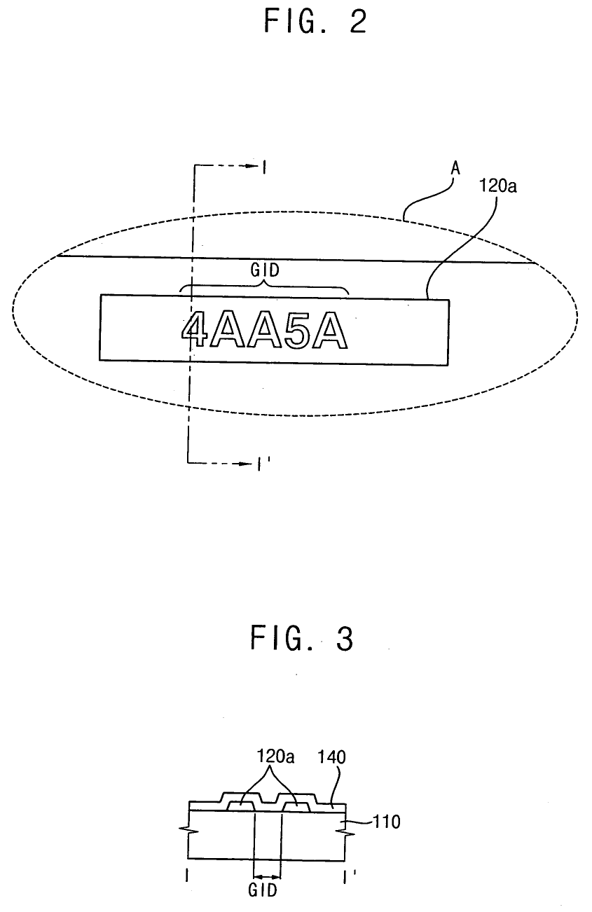

FIG. 1 is a plan view showing a mother panel substrate for a liquid crystal display (LCD) device in accordance with one embodiment of the present invention. FIG. 2 is a plan view showing portion ‘A’ in FIG. 1, and FIG. 3 is a cross-sectional view taken along a line I-I′ in FIG. 2.

Referring to FIGS. 1 to 3, the mother panel substrate 100 includes a base substrate 110, a first glass identification display part 120a, a second glass identification display part 120b and a plurality of cell identification display parts 130. The first and second glass identification display parts 120a and 120b and the cell identification display parts 130 are included on the base substrate 110.

The base substrate 110 includes a transparent material. Examples of the transparent material that can be used for the base substrate 110 include a glass, quartz, and a synthetic resin. The base substrate 110 is includes a cell array region CAA and a non-cell array region NCA that surrounds the cell array region CAA.

The cell array region CAA includes a plurality of cell regions. The cell regions form a cell array arranged in a matrix shape having first, second, . . . i-th row arrays MH1, MH2, . . . Mhi and first, second, . . . j-th columns MV1, MV2, . . . MVj, wherein i and j are natural numbers.

The mother panel substrate 100 is divided into cell regions. Each of the cell regions may be one of a thin film transistor (TFT) substrate and a color filter substrate.

The first and second glass identification display parts 120a and 120b are formed in the non-cell array region NCA. The first glass identification display part 120a is located on an upper portion of the base substrate 110, and the second glass identification display part 120b is located on a lower portion of the base substrate 110.

In FIGS. 1 to 3, the second glass identification display part 120b has a substantially same shape as the first glass identification display part 120a. Thus, only first glass identification part 120a is described below.

Referring again to FIGS. 2 and 3, the first glass identification display part 120a is on the base substrate 110, and includes a metal.

A glass identification (GID) of the mother panel substrate 100 for the LCD device is formed on the first glass identification display part 120a. The mother panel substrate 100 identifiable from another mother panel substrate by the glass identification GID. The glass identification GID identifies the mother panel substrate 100. The glass identification GID may be printed on the first glass identification display part 120a. A glass identification GID may also be printed on the second glass identification display part 120b. For example, when the glass identification GID is ‘4AA5A’, ‘4AA5A’ is printed on the first glass identification display part 120a and ‘4AA5A’ is also printed on the second glass identification display part 120b.

When the cell array regions CAA are severed to form the TFT substrates or the color filter substrates, the non-cell array regions NCA are removed. The first and second glass identification display parts 120a and 120b are in the non-cell array regions NCA to be removed from the TFT substrates or the color filter substrates.

A gate insulating layer 140 is formed on the base substrate 110 having the first glass identification display part 120a. The gate insulating layer 140 may include an insulating material that has a high adhesive strength against the metal. Examples of the insulating material that can be used for the gate insulating layer 140 include silicon oxide, and silicon nitride. The gate insulating layer 140 may be formed through a plasma-enhanced chemical vapor deposition (PECVD) process.

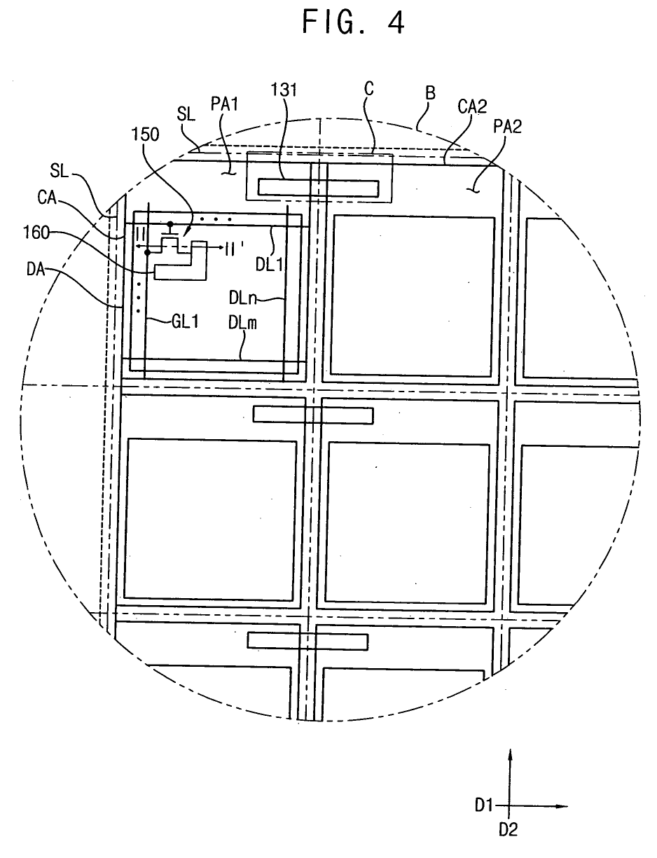

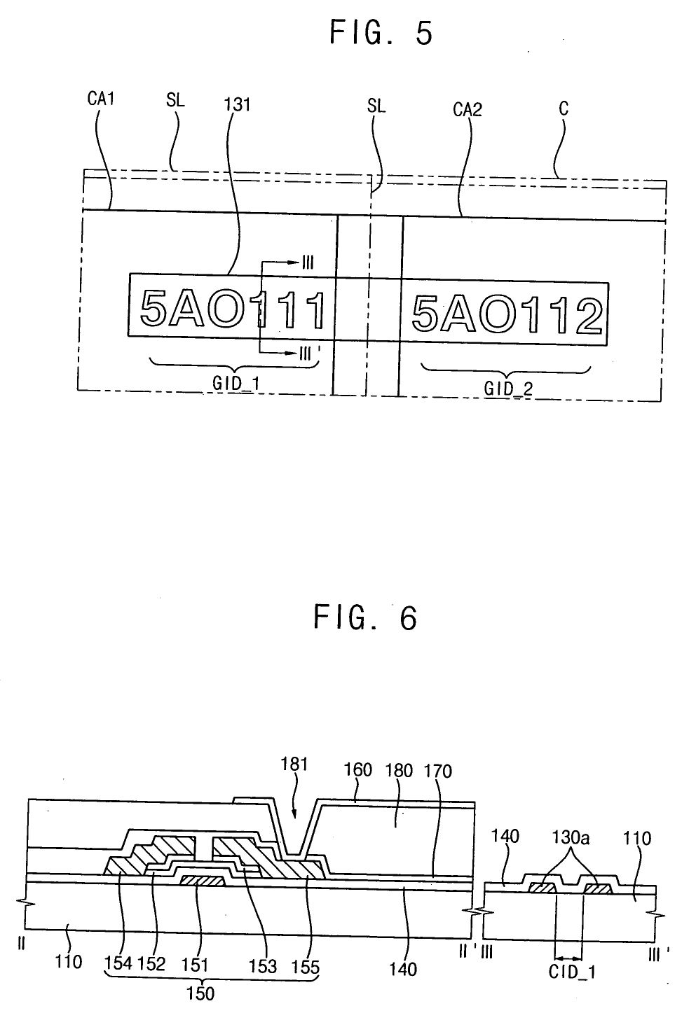

FIG. 4 is a plan view showing portion ‘B’ FIG. 1. FIG. 5 is a plan view showing a portion ‘C’ in FIG. 4. FIG. 6 is a cross-sectional view taken along a line II-II′ of FIG. 4 and a line III-III′ of FIG. 5.

Referring to FIGS. 1 to 6, the cell regions have a substantially same structure and elements. Accordingly only one of the cell regions is described below.

A first cell region CA1 includes a display region DA and a non-display region PA1 that surrounds the display region DA. An image is not displayed in the non-display region PA1.

A plurality of gate lines GL1, . . . GLn, a plurality of data lines DL1, . . . DLm, a plurality of thin film transistors TFT 150 and a plurality of pixel electrodes 160 are formed on the display region DA of the base substrate 110. ‘n’ and ‘m’ are natural numbers.

The gate lines GL1, . . . GLn transmit gate signals that may be provided from an exterior to the LCD panel. The data line DL1, . . . DLm cross the gate lines GL1, . . . GLn, and are electrically insulated from the gate lines GL1, . . . GLn. The gate and data lines GL1, . . . GLn and DL1, . . . DLm define a plurality of pixel regions in the display region DA.

Referring again to FIGS. 4 and 6, the thin film transistors 150 are in the pixel regions, respectively. Each of the TFTs 150 is electrically connected to one of the gate lines GL1, . . . GLn and one of the data lines DL1, . . . DLm. Each of the thin film transistors 150 includes a gate electrode 151, an active layer 152, an ohmic contact layer 153, a source electrode 154 and a drain electrode 155.

The gate electrode 151 is electrically connected to one of the gate lines GL1, . . . GLn. The gate electrode 151 may be formed from substantially the same layer as the first and second glass identification display parts 120a and 120b. The gate electrode 151 may include a substantially same material as the first and second glass identification display parts 120a and 120b.

The gate insulating layer 140 is on the base substrate 110 having the gate electrode 151. The active layer 152 is on the gate insulating layer 140 corresponding to the gate electrode 151. The active layer 152 may include amorphous silicon.

The ohmic contact layer 153 is on the active layer 152, and includes n+amorphous silicon. A central portion of the ohmic contact layer 153 is partially removed so that a portion of the active layer 152 between the source and drain electrodes 154 and 155 is exposed. The active layer 152 includes a channel region between the source and drain electrodes 154 and 155.

The source electrode 154 and the drain electrode 155 are beneath the ohmic contact layer 153. The source electrode 154 is electrically connected to one of the data lines DL1, . . . DLm. The drain electrode 155 corresponds to the source electrode 154 with respect to the channel region.

The pixel electrode 160 is electrically connected to the drain electrode 155 of each of the thin film transistors 150. The pixel electrode 160 includes a transparent conductive material. Examples of the transparent conductive material that can be used for the pixel electrode 160 include indium tin oxide (ITO), and indium zinc oxide (IZO).

The mother panel substrate 100 may further include a passivation layer 170 and an organic insulating layer 180. The passivation layer 170 is on the gate insulating layer 140 to cover the thin film transistors 150.

The organic insulating layer 180 is on the passivation layer 170. The pixel electrode 160 is on the organic insulating layer 180. The passivation layer 170 and the organic insulating layer 180 are partially removed to form a contact hole 181 through which the drain electrode 155 is partially exposed. The pixel electrode 160 is electrically connected to the drain electrode 155 through the contact hole 181.

Referring to FIGS. 1 to 5, the cell identification display parts 130 are in the cell array region CAA. The cell identification display parts 130 include a metal. Each of the cell identification display parts 130 includes portions on two adjacent cell regions.

The cell identification display parts 130 have a substantially same structure, and accordingly only one of them is described below.

A first cell identification display part 131 includes a portion on first cell region CA1 and a second portion on second cell region CA2 which is adjacent to the first cell region CA1. The first and second cell regions CA1 and CA2 are on the first row MH1. That is, the first and second cell regions CA1 and CA2 are adjacent to each other, and on adjacent columns of the columns MV1, . . . MVj that are arranged in a first direction D1.

The first cell identification display part 131 is on a peripheral region PA1 of the first cell region CA1 and a peripheral region PA2 of the second cell region CA2. In particular, the first cell identification display part 131 is on a corner between the first and second cell regions CA1 and CA2.

Referring again to FIGS. 5 and 6, the first cell identification display part 131 is on the base substrate 110, and includes a metal. The first cell identification display part 131 may be formed from the same layer as the gate electrode 151, and includes a substantially same material as the gate electrode 151. Alternatively, the first cell identification display part 131 may be formed from the same layer as the source and drain electrodes 154 and 155, and may include a substantially same material as the source and drain electrodes 154 and 155.

The first cell identification display part 131 is on the peripheral region PA1 of the first cell region CA1 and the peripheral region PA2 of the second cell region CA2 so that the first cell identification display part 131 remains in the LCD panel.

A first cell identification mark GID_1 corresponding to the first cell region CA1 and a second cell identification mark GID_2 corresponding to the second cell region CA2 are on the first cell identification display part 131. The first and second cell identification marks GID_1 and GID_2 are different from each other. Each of the first and second cell identification marks GID_1 and GID_2 function as a serial number. Each of the first and second cell identification marks GID_1 and GID_2 may include, for example information of a manufacturing date, a brand, a glass identification, and a location data of the cell region in the base substrate 110. The first and second cell identification marks GID_1 and GID_2 may be used for a management of the LCD panel.

The first cell identification mark GID_1 corresponds to the first cell region CA1, and the second cell identification mark GID_2 corresponds to the second cell region CA2.

The first cell identification mark GID_1 is in the first cell region CA1, and the second cell identification mark GID_2 is in the second cell region CA2. The second cell identification mark GID_2 is opposite to the first cell identification mark GID_1 with respect to a severing line SL. The cell array is cut along the severing line SL on the mother panel substrate 100.

When the mother panel substrate 100 is cut along severing line SL, the first cell identification display part 131 is divided into two parts that are in the first and second cell regions CA1 and CA2, respectively.

The first and second cell identification marks GID_1 and GID_2 are printed on the first cell identification display part 131. For example, the first and second cell identification marks GID_1 and GID_2 are ‘5A0111’ and ‘5A0112’, respectively, and ‘5A0111’ and ‘5A0112’ are printed on the first cell identification display part 131. The first and second cell identification marks GID_1 and GID_2 may be printed by a titling device (not shown). The titling device (not shown) may irradiate a laser beam on the first cell identification display part 131 to form the first and second cell identification marks GID_1 and GID_2. The first cell identification mark GID_1 is then separated from the second cell identification mark GID_2 by a cutting device.

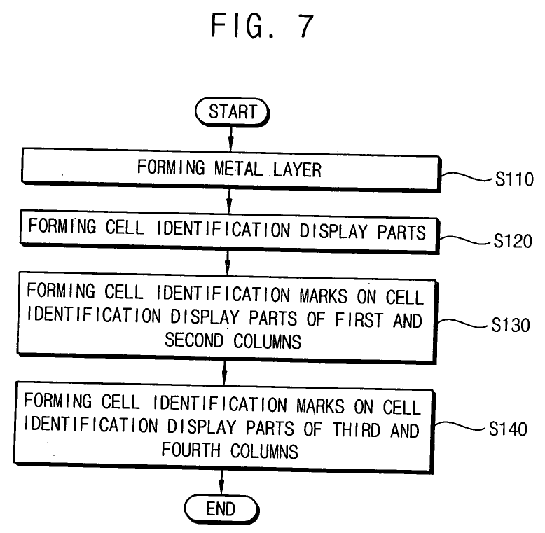

FIG. 7 is a flow chart showing a method of manufacturing the mother panel substrate for the LCD device in FIG. 1.

Referring to FIGS. 1 and 7, a metal layer is formed on the base substrate 110 (step S110).

The metal layer is patterned to form the cell identification display parts 130 (step S120). The gate lines GL1, . . . GLn (in FIG. 4), the gate electrode 151 (in FIG. 6) and the first and second glass identification display parts 120a and 120b may also be formed from the metal layer.

The titling device is arranged on the base substrate 110, and transported from an i-th row MHi (wherein i denotes a natural number) to a first row MHi to form the cell identification marks on the cell identification display parts of the first and second columns MV1 and MV2 (step S130). The i-th row MHi is the last row of the cell array. Thus, the cell identification marks on the first and second columns MV1 and MV2 are formed. The cell identification marks may be formed on the first and second columns MV1 and MV2 in a reverse order.

One cell identification display part is formed on the two adjacent cell regions. The titling device forms two cell identification marks on the one cell identification display part, and then is transported to a previous row. For example, the titling device forms the two cell identification marks on the cell identification display part of the i-th row MHi of the first and second columns MV1 and MV2, and then is transported to an (i-1)-th row MHi-1 of the first and second columns MV1 and MV2.

The titling device is arranged on the first and second columns MV1 and MV2 of the first row MH1. The titling device is then transported into third and fourth columns MV3 and MV4 of the first row MH1. The titling device is then transported from the first row MH1 to the i-row MHi to form the cell identification marks on the cell identification display parts of the third and fourth columns MV3 and MV4 (step S140). Thus, the cell identification marks on the third and fourth columns MV3 and MV4 are formed. The cell identification marks may be formed on the third and fourth columns MV3 and MV4 in a normal order.

One cell identification display part is formed on the two adjacent cell regions. The titling device forms two cell identification marks on the one cell identification display part, and then is transported to a next row. When the titling device scans the first to i-th rows in one of the normal order and the reverse order, the cell identification marks are formed on the cell regions of the two adjacent rows. The transportation of the normal order and the transportation of the reverse order are alternately repeated.

The titling device is transported to a j-th column MVj (wherein j denotes a natural number) to form the cell identification marks. A first scan path SD1 (as shown in FIG. 1) represents a path of the titling device.

A path of the titling device is described below. The cell identification display part may be on each of cell regions.

Each of the cell identification display parts 130 is formed on the two adjacent cell regions arranged in the first direction D1. The titling device is transported along the first scan path SD1, and forms the cell identification marks on the two columns of the cell array in every scan. The titling device scans the cell array from the first row MH1 to the i-th row MHi in the normal order or in the reverse order.

For example, when the titling device is transported from the first row MH1 to the i-th row MHi along the first and second columns MV1 and MV2, the cell identification marks are formed the cell regions, respectively. The number of the cell regions in each of the columns is ‘i’ so that the number of the cell identification marks formed by the titling device in each of the scans is 2xi.

However, when the cell identification display part is divided into each of the cell regions, the number of the cell identification marks formed by the titling device in each of the scans along a second scan path SD2 is ‘i’.

For example, when the cell identification display part is divided into each of the cell regions, the titling device is transported from the first row MH1 to the i-th row MHi along the first column MV1 to form the cell identification marks corresponding to the first column MV1. Therefore, the titling device is scanned two times to form the cell identification marks on the first and second columns MV1 and MV2. In particular, the titling device is transported from the first row MH1 to the i-th row MHi along the first column MV1 in the normal order, and the titling device is transported from the i-th row MHi to the first row MH1 along the second column MV2 in the reverse order.

However, when the cell identification display part is in the adjacent two cell regions, the number of the scanning of the titling device is decreased to be about a half of the number of the scanning the cell identification display part in each of the cell regions. That is, the mother panel substrate 100 includes the cell identification display part in the two adjacent cell regions to decrease the number of the scanning the cell identification marks.

In addition, the first scan path SD1 has about a half length of the second scan path SD2 to decrease a manufacturing time of the cell identification marks. Therefore, a manufacturing time of the mother panel substrate 100 for the LCD device is saved, thereby reducing a manufacturing cost of the mother panel substrate 100.

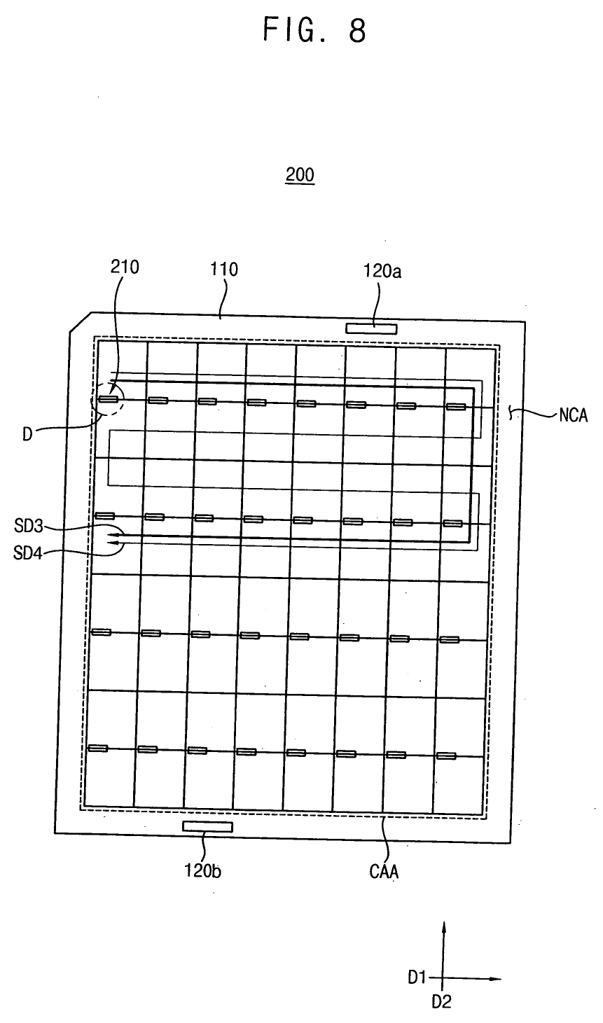

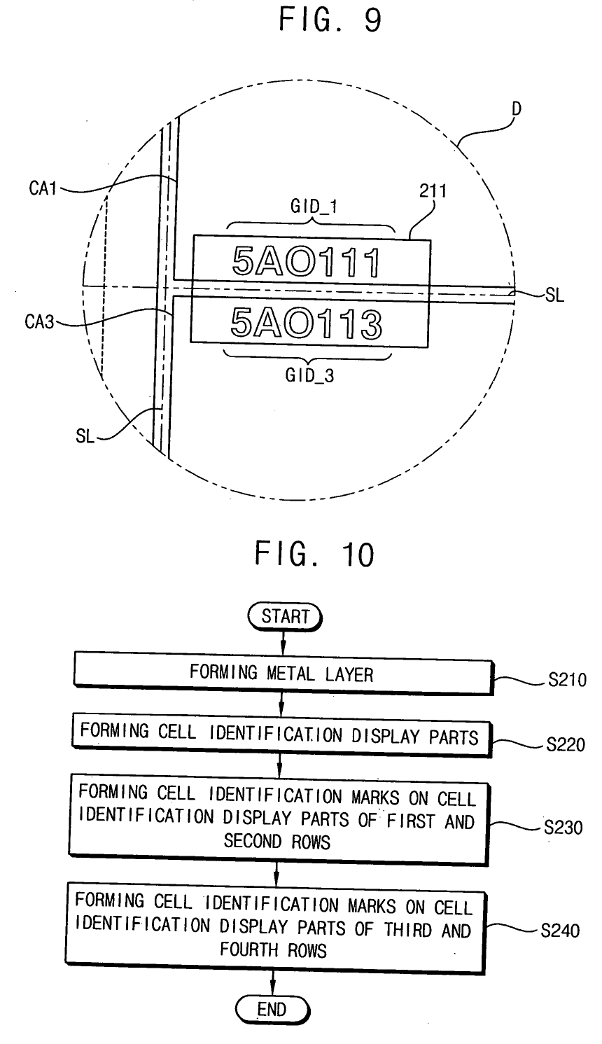

FIG. 8 is a plan view showing a mother panel substrate for an LCD device in accordance with another embodiment of the present invention. FIG. 9 is a plan view showing portion ‘D’ in FIG. 8.

The mother panel substrate of FIGS. 8 and 9 is same as in FIG. 1 except for cell identification display part. Thus, the same reference numerals will be used to refer to the same or like parts as those described in FIGS. 8 to 9 and any further explanation concerning the above elements will be omitted.

Referring to FIGS. 8 and 9, the mother panel substrate 200 includes a base substrate 110, a first glass identification display part 120a, a second glass identification display part 120b and a plurality of cell identification display parts 210. The first and second glass identification display parts 120a and 120b and the cell identification display parts 210 are on the base substrate 110.

Each of the cell identification display parts 210 is formed on two adjacent cell regions of a cell array that are arranged in a second direction D2. A plurality of rows MH1, . . . MHi is aligned in the second direction D2.

The cell identification display parts 210 have a substantially same structure as cell identification parts 131 of the first embodiment. Accordingly, any further explanation concerning the above elements will be omitted.

A first cell identification display part 211 is on a first cell region CA1 and a third cell region CA3 adjacent to the first cell region CA1. The first and third cell regions CA1 and CA3 are arranged in the second direction D2. The first cell identification display part 211 is on a peripheral region PA1 of the first cell region CA1 and a peripheral region PA3 of the third cell region CA3. In particular, the first cell identification display part 211 is on a corner between the first and third cell regions CA1 and CA3.

The first cell identification display part 211 is on the base substrate 110, and includes a metal. The first cell identification display part 211 may be formed from a substantially same layer as a gate electrode, and includes a substantially same material as the gate electrode. Alternatively, the first cell identification display part 211 may be formed from a substantially same layer as source and drain electrodes, and may include a substantially same material as the source and drain electrodes.

A first cell identification mark GID_1 corresponding to the first cell region CA1 and a third cell identification mark GID₁₃ 3 corresponding to the third cell region CA3 are on the first cell identification display part 211.

The first cell identification mark GID₁₃ 1 corresponds to the first cell region CA1, and the third cell identification mark GID₁₃ 3 corresponds to the third cell region CA3.

The first cell identification mark GID_1 is in the first cell region CA1, and the third cell identification mark GID₁₃ 3 is in the third cell region CA3. The third cell identification mark GID₁₃ 3 is opposite to the first cell identification mark GID_1 with respect to a severing line SL. The cell array is cut along the severing line SL on the mother panel substrate 100. A cutter cuts the mother panel substrate 100 along the severing line SL. When the mother panel substrate 100 is cut along the severing line SL, the first cell identification display part 211 is divided into two parts that are in the first and third cell regions CA1 and CA3, respectively.

The first and third cell identification marks GID_1 and GID₁₃ 3 are printed on the first cell identification display part 211. For example, the first and third cell identification marks GID_1 and GID₁₃ 3 are ‘5A0111’ and ‘5A0113’, respectively, and ‘5A0111’ and ‘5A0113’ are printed on the first cell identification display part 211.

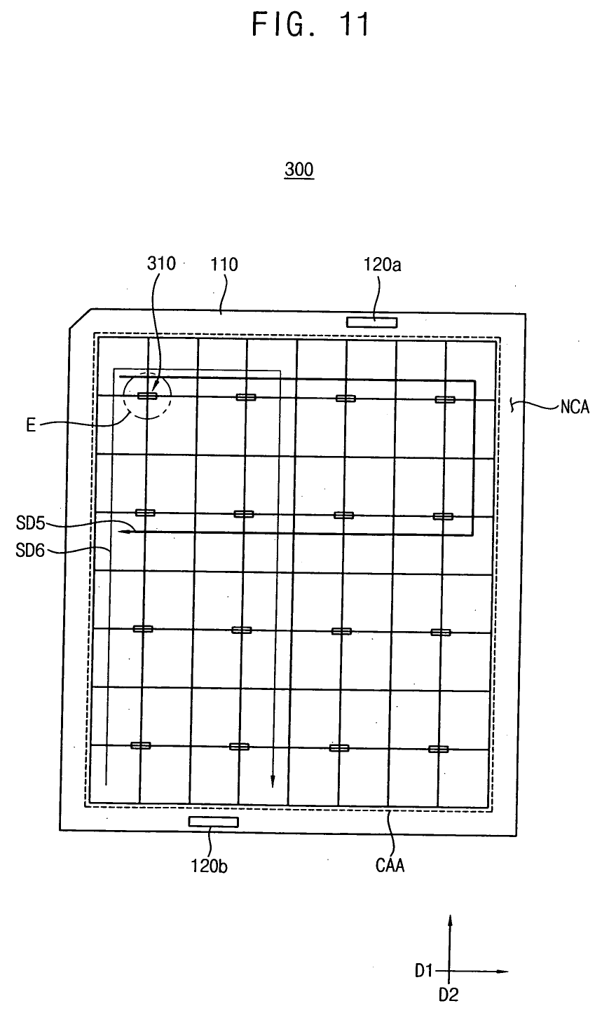

FIG. 10 is a flow chart showing a method of manufacturing the mother panel substrate in FIG. 8.

Referring to FIGS. 8 and 10, a metal layer is formed on the base substrate 110 (step S210).

The metal layer is patterned to form the cell identification display parts 210 (step S220). The gate lines GL1, . . . GLn (in FIG. 4), the gate electrode 151 (in FIG. 6) and the first and second glass identification display parts 120a and 120b may also be formed from the metal layer.

The titling device is arranged on the base substrate 110, and transported from the first column MV1 to the j-th column MVj to form the cell identification marks on the cell identification display parts of the first and second rows MH1 and MH2 (step S230). Thus, the cell identification marks on the first and second rows MH1 and MH2 are formed. The cell identification marks may be formed on the first and second rows MH1 and MH2 in a normal order.

One cell identification display part is formed on the two adjacent cell regions. The titling device forms two cell identification marks on the one cell identification display part, and then is transported to a next column. For example, the titling device forms the two cell identification marks on the cell identification display part of the first column MV1 of the first and second rows MH1 and MH2, and then is transported to a second column MV2 of the first and second rows MH1 and MH2.

The titling device is arranged on the first and second rows MH1 and MH2 of the j-th column MVj. The titling device is then transported into third and fourth rows MH3 and MH4 of the j-th column MVj. The titling device is then transported from the j-th column MVj to the first column MV1 to form the cell identification marks on the cell identification display parts of the third and fourth rows MH3 and MH4. Thus, the cell identification marks on the third and fourth rows MH3 and MH4 are formed (step S240). The cell identification marks may be formed on the third and fourth rows MH3 and MH4 in a reverse order.

One cell identification display part is formed on the two adjacent cell regions. The titling device forms two cell identification marks on the one cell identification display part, and then is transported to a previous column. When the titling device scans the first to j-th columns in one of the normal order and the reverse order, the cell identification marks are formed on the cell regions of the two adjacent columns. The transportation of the normal order and the transportation of the reverse order are alternately repeated.

The titling device is transported to the i-th row MHi to form the cell identification marks. A third scan path SD3 (in FIG. 9) represents a path of the titling device.

Hereinafter, a path of the titling device is described. The cell identification display part may be on each of cell regions.

Each of the cell identification display parts 211 is formed on the two adjacent cell regions arranged in the second direction D2. The titling device is transported along the third scan path SD3, and forms the cell identification marks on the two columns of the cell array in every scan. The titling device scans the cell array from the first column MV1 to the j-th column MVi in the normal order or in the reverse order.

For example, when the titling device is transported from the first column MV1 to the j-th column MVj along the first and second rows MH1 and MH2, the cell identification marks are formed the cell regions, respectively. The number of the cell regions in each of the columns is ‘j’ so that the number of the cell identification marks formed by the titling device in each of the scans is 2xj.

However, when the cell identification display part is divided into each of the cell regions, the number of the cell identification marks formed by the titling device in each of the scans along a fourth scan path SD4 is ‘j’.

For example, when the cell identification display part is divided into each of the cell regions, the titling device is transported from the first column MV1 to the j-th column MVj along the first row MH1 to form the cell identification marks corresponding to the first row MH1. Therefore, the titling device is scanned two times to form the cell identification marks on the first and second rows MH1 and MH2. In particular, the titling device is transported from the j-th column MVj to the first column MV1 along the first row MH1 in the reverse order, and the titling device is then transported from the first column MH1 to the j-th column MHj along the second row MH2 in the normal order.

However, when the cell identification display part is in the adjacent two cell regions, the number of the scanning of the titling device is decreased to be about a half of the number of the scanning the cell identification display part in each of the cell regions. That is, the mother panel substrate 200 includes the cell identification display part in the two adjacent cell regions to decrease the number of the scanning the cell identification marks.

In addition, the third scan path SD3 has about a half length of the fourth scan path SD4 to decrease a manufacturing time of the cell identification marks. Therefore, a manufacturing time of the mother panel substrate 200 for the LCD device is saved, thereby reducing a manufacturing cost of the mother panel substrate 200.

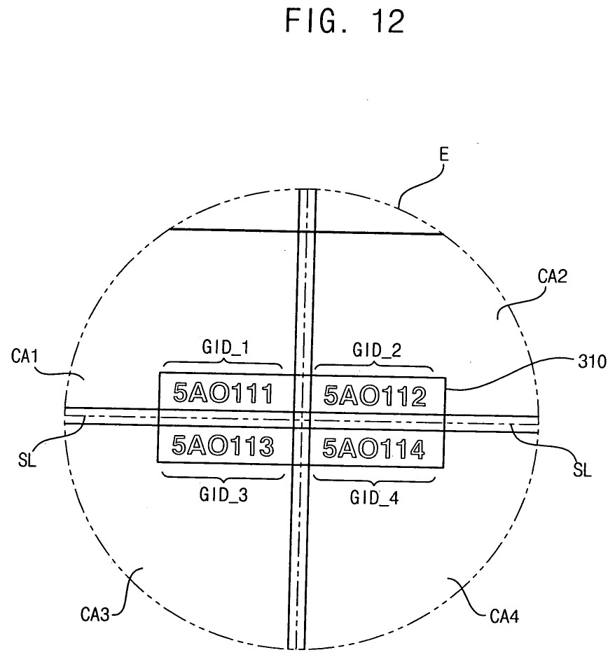

FIG. 11 is a plan view showing a mother panel substrate for an LCD device in accordance with another embodiment of the present invention. FIG. 12 is a plan view showing portion ‘E’ in FIG. 11.

The mother panel substrate of FIGS. 11 and 12 is same as in FIG. 1 except with respect to the cell identification display part. Thus, the same reference numerals will be used to refer to the same or like parts as those described in FIGS. 11 and 12 and any further explanation concerning the above elements will be omitted.

Referring to FIGS. 11 and 12, the mother panel substrate 300 includes a base substrate 110, a first glass identification display part 120a, a second glass identification display part 120b and a plurality of cell identification display parts 310. The first and second glass identification display parts 120a and 120b and the cell identification display parts 310 are on the base substrate 110.

Each of the cell identification display parts 310 is formed on four adjacent cell regions of a cell array.

The cell identification display parts 310 have a substantially the same structure as the cell identification display parts described above. Thus, any further explanation concerning the above elements will be omitted.

A first cell identification display part 310 is on a first cell region CA1, a second cell region CA2, a third cell region CA3 and a fourth cell region CA4. The first, second, third and fourth cell regions CA1, CA2, CA3 and CA4 are adjacent to each other. The first and second cell regions CA1 and CA2 are arranged on a first row MH1. The third and fourth cell regions CA3 and CA4 are arranged on a second row MH2. The first and third cell regions CA1 and CA3 are arranged on a first column MV1. The second and fourth cell regions CA2 and CA4 are arranged on a second row MV2.

The first cell identification display part 310 is on a peripheral region PA1 of the first cell region CA1, a peripheral region PA2 of the second cell region CA2, a peripheral region PA3 of the third cell region CA3 and a peripheral region PA4 of the fourth cell region CA4. In particular, the first cell identification display part 311 is on a corner between the first, second, third and fourth cell regions CA1, CA2, CA3 and CA4.

The first cell identification display part 310 is on the base substrate 110, and includes the metal. The first cell identification display part 310 may be formed from a substantially same layer as a gate electrode, and includes a substantially same material as the gate electrode. Alternatively, the first cell identification display part 311 may be formed from a substantially same layer as source and drain electrodes, and may include a substantially same material as the source and drain electrodes.

A first cell identification mark GID_1 corresponding to the first cell region CA1, a second cell identification mark GID_2 corresponding to the second cell region CA2, a third cell identification mark GID₁₃ 3 corresponding to the third cell region CA3 and a fourth cell identification mark GID₁₃ 4 corresponding to the fourth cell region CA4 are on the first cell identification display part 310.

The first cell identification mark GID₁₃ 1 corresponds to the first cell region CA1. The second cell identification mark GID_2 corresponds to the second cell region CA2. The third cell identification mark GID₁₃ 3 corresponds to the third cell region CA3. The fourth cell identification mark GID₁₃ 4 corresponds to the fourth cell region CA4.

The first cell identification mark GID_1 is in the first cell region CA1. The second cell identification mark GID_2 is in the second cell region CA2. The third cell identification mark GID₁₃ 3 is in the third cell region CA3. The fourth cell identification mark CID₁₃ 4 is in the fourth cell region CA4.

The first cell identification mark GID_1 is opposite to the second and third cell identification marks GID_2 and GID₁₃ 3 with respect to a severing line SL. The fourth cell identification mark GID₁₃ 4 is substantially in a diagonal direction with respect to the first cell identification mark GID_1. The fourth cell identification mark CID₁₃ 4 is opposite to the second and third cell identification marks CID₁₃ 2 and CID₁₃ 3 with respect to the severing line SL.

The cell array is cut along the severing line SL on the mother panel substrate 300. The first cell identification display part 310 is divided into four parts that are in the first, second, third and fourth cell regions CA1, CA2, CA3 and CA4, respectively.

The first, second, third and fourth cell identification marks GID_1, GID_2, GID₁₃ 3 and GID₁₃ 4 are printed on the first cell identification display part 310.

The titling device is scanned the cell array along two adjacent columns or along two adjacent rows. That is, the titling device is transported the cell array along the two adjacent columns or along the two adjacent rows.

For example, the titling device may be transported from the first column MV1 to the j-th column MVj along the first and second rows MH1 and MH2 to form the cell identification marks on the cell identification display parts of the first and second rows MH1 and MH2. The cell identification marks may be formed on the first and second rows MH1 and MH2 in a reverse order. In particular, the titling device forms the four cell identification marks in the one cell identification display part, and shifted into another cell identification display part.

Thus, the cell identification marks are formed in the cell regions of the first and second rows MH1 and MH2. A fifth scan path SD5 represents a path of the titling device on the cell array.

Alternatively, the titling device may also be transported from the i-th row MHi to the first row MH1 along the first and second columns MV1 and MV2 to form the cell identification marks on the cell identification display parts of the first and second columns MV1 and MV2. The cell identification marks may be formed on the first and second columns MV1 and MV2 in a reverse order. In particular, the titling device forms the four cell identification marks in the one cell identification display part, and shifted into another cell identification display part.

Thus, the cell identification marks may be formed in the cell regions of the first and second columns MV1 and MV2. A sixth scan path SD6 represents a path of the titling device on the cell array.

When the cell identification display part is in the adjacent four cell regions, the number of the scanning of the titling device is decreased to be about a quarter of the number of the scanning the cell identification display part in each of the cell regions. That is, the mother panel substrate 300 includes the cell identification display part in the four adjacent cell regions to decrease the number of the scanning the cell identification marks.

In addition, the fifth scan path SD5 or the sixth scan path SD6 has about a half length of the second scan path SD2 or the fifth scan path SD4 to decrease a manufacturing time of the cell identification marks. Therefore, the manufacturing time of the mother panel substrate 300 for the LCD device is decreased, thereby reducing the manufacturing cost of the mother panel substrate 300.

According to the present invention, the mother panel substrate for manufacturing the display device includes a cell identification display part on adjacent two cell regions so that the number of the cell identification display parts is decreased. A plurality of cell identification marks is formed on each of the cell identification display parts. The cell identification display marks correspond to the cell regions, respectively. The titling device scans the cell array in a direction that is substantially perpendicular to an arrangement of the adjacent cell regions. The titling device forms the two cell identification marks in one of the cell identification display parts, and is then transported to the adjacent cell identification display part.

In addition, the scan path of the titling device is decreased to decrease the manufacturing time of the cell identification marks. Therefore, the manufacturing time of the mother panel substrate is reduced, thereby decreasing the manufacturing cost of the mother panel substrate.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A mother panel substrate for a display device comprising:
a base substrate having a plurality of cell regions; and
a cell identification display part comprising a plurality of cell identification marks located on a plurality of cell regions, each of the cell identification marks being located in adjacent cell regions, wherein the cell identification marks uniquely identify as associated cell region.

2. The mother panel substrate of claim 1, wherein the cell identification display part comprises two cell identification marks located on two adjacent cell regions.

3. The mother panel substrate of claim 2, wherein the cell regions are arranged in a matrix having at least one row of cells and at least two columns of cells, and the adjacent two cell regions are positioned in a row direction.

4. The mother panel substrate of claim 2, wherein the cell regions are arranged in a matrix having at least two rows and at least one column, and the adjacent two cell regions are positioned in a column direction.

5. The mother panel substrate of claim 1, wherein the cell identification display part comprises four cell identification marks located on four adjacent cell regions.

6. The mother panel substrate of claim 5, wherein the cell regions are arranged in a matrix having at least two rows and at least two columns.

7. The mother panel substrate of claim 5, wherein the cell identification display part is located at a corner common to the four adjacent cell regions.

8. The mother panel substrate of claim 1, wherein the base substrate further comprises a severing line between cell regions, and two adjacent cell regions are on opposite sides of the severing line.

9. The mother panel substrate of claim 1, wherein each of the cell regions comprises a display region adapted to display an image, and a peripheral region that surrounds the display region, and further wherein each of the cell identification marks is located in the peripheral region.

10. The mother panel substrate of claim 1, further comprising a glass identification display part positioned on the base substrate, wherein the glass identification display part includes a glass identification mark to identify the base substrate.

11. The mother panel substrate of claim 10, wherein the glass identification mark is in a second peripheral region that surrounds the cell regions.

12. The mother panel substrate of claim 1, wherein the cell identification marks are printed on the cell identification display part, and includes manufacturing date data.

13. A method of manufacturing a mother panel substrate for a display device comprising:
forming a metal layer on a base substrate having a plurality of cell regions; and
patterning the metal layer to form a cell identification display part on a plurality of adjacent cell regions, wherein the cell identification display part includes a plurality of cell identification marks each of which is associated with each cell region of the adjacent cell regions and identifies the associated cell region.

14. The method of claim 13, wherein the cell regions are arranged in a matrix shape.

15. The method of claim 14, wherein the cell identification marks are formed by a titling device that radiates a laser beam.

16. The method of claim 14, wherein the cell identification display part is located on two adjacent cell regions that are positioned in a row direction.

17. The method of claim 16, wherein the titling device is transported along the row direction and form two cell identification marks on the adjacent two cell regions of two adjacent columns of the matrix.

18. The method of claim 14, wherein the cell identification display part is located on two adjacent cell regions positioned in a column direction.

19. The method of claim 18, wherein the titling device is transported along columns to form two cell identification marks on the adjacent two cell regions of two adjacent rows of the matrix.
